(19) United States
(12) Patent Application Publication
(10) Pub. No.: US 2026/0285752 A1
(43) Pub. Date: Sep. 24, 2026

(54) METHOD FOR PRODUCING AN ORGANIC- OR ORGANIC/MINERAL-BASED AGGREGATE, ORGANIC- OR ORGANIC/MINERAL-BASED AGGREGATE AND USES THEREOF

(71) Applicant: NÉOLITHE, BEAULIEU-SUR-LAYON (FR)

(72) Inventors: Louis JARDIN, Angers (FR); François-Xavier HERMELLIN, Angers (FR); William Francis CRUAUD, Val-du-Layon (FR)

(21) Appl. No.: 19/141,423

(22) PCT Filed: Dec. 20, 2023
(86) PCT No.: PCT/IB2023/063042

§ 371 Date: Jun. 20, 2025

(30) Foreign Application Priority Data
Dec. 21, 2022 (FR) FR2214183

(51) Int. Cl. C04B 18/02; C04B 28/04

(52) U.S. Cl. CPC C04B 18/021; C04B 28/04

(57) ABSTRACT

The invention relates to a process for manufacturing an aggregate, characterized in that at least one particulate organic or organic/mineral starting material for aggregate is mixed with water and at least one mineral binder which can be hardened in the presence of water and/or at least one system capable of forming a hardened mineral binder in an aqueous medium, in order to obtain a material in the form of a wet powder which is compressed by extrusion or pressing in order to intimately mix the binder and/or a system capable of forming the binder/the particulate starting material/water and to increase the intrinsic density and reduce the intrinsic porosity of the material, and to obtain, as a result of the hardening of the binder or binders, a hardened, solid mass which is in the form of the aggregate of the size and/or shape desired, or is transformed into the aggregate of the size and/or shape desired by cutting or crushing, immediately after compression or in a subsequent stage.

The present invention relates to a process for manufacturing an organic or organic/mineral-based aggregate, to an organic or organic/mineral-based aggregate obtainable by this process, and to applications for these aggregates.

As part of the current drive to save resources and limit waste, circular economy solutions have been widely adopted in the building and public works sector, particularly to save on new aggregates. Crushed concrete, incinerator bottom ash and crystallised slag are currently being used as aggregates to replace natural aggregates extracted from quarries.

However, these aggregate production methods are not sufficient to solve the problems of overproduction of waste and the lack of aggregate resources.

It is the aim of the present invention to satisfy this need, the process proposed for this purpose consisting in selecting at least one organic or organic/mineral granular base material having a large specific surface area or in grinding at least one organic or organic/mineral granular base material so that it achieves such a particle size by increasing its specific surface area, in adding at least one binder and water, in pressurising the assembly and in shaping it to form the desired aggregate.

The first object of the present invention is therefore a process for manufacturing an aggregate, characterized in that at least one particulate organic or organic/mineral starting material for aggregate is mixed with water and at least one mineral binder which can be hardened in the presence of water and/or at least one system capable of forming a hardened mineral binder in an aqueous medium, in order to obtain a material in the form of a wet powder which is compressed by extrusion or pressing in order to intimately mix the binder and/or a system capable of forming the binder/the particulate starting material/water and to increase the intrinsic density and reduce the intrinsic porosity of the material, and to obtain, as a result of the hardening of the binder or binders, a hardened, solid mass which is in the form of the aggregate of the size and/or shape desired, or is transformed into the aggregate of the size and/or shape desired by cutting or crushing, immediately after compression or in a subsequent stage.

The starting particulate organic material may be selected from wood, paper, cardboard, plastics, plant materials such as flax fiber, hemp fiber or cellulose fiber, insulating materials such as wood wool, household waste, biogenic waste, bituminous waste and mixtures thereof.

The starting particulate organic/mineral material may be selected from non-hazardous non-inert waste such as building waste and ordinary industrial waste, household waste or tertiary waste, and from the organic materials listed above in a mixture with at least one particulate mineral material chosen in particular from sands, such as silica sand and basalt sand; non-reactive clays; sediments, such as dredging sediments; glass; gypsum; coal; crushed concrete; crushed aggregates; insulating materials such as glass wool and rock wool; quarry fines; industrial process fines; and mixtures thereof.

Particular mention may be made of non-hazardous non-inert wastes which constitute mixtures of organic/mineral materials to be used directly as starting materials in the process according to the present invention. Particular mention may be made of building waste, such as demolition or construction waste from a building comprising, in particular, wood, plastics, glass wool, metals or ordinary industrial waste, household waste or tertiary waste.

As can be understood, waste materials from various sources represent direct mixtures of starting materials according to the invention, the proportions of which change depending on the source.

The starting particulate organic or organic/mineral material or mixture of starting particulate mineral materials may have a particle size defined by:
a D90 value less than or equal to 2 mm, preferably to 1.5 mm, even more preferably to 1.1 mm;
a D10 value greater than or equal to 0.01 mm, preferably to 0.02 mm, even more preferably to 0.03 mm; and
a D50 value greater than or equal to 0.1 mm, preferably to 0.2 mm, even more preferably to 0.35 mm, and less than or equal to 1.1 mm, preferably to 0.8 mm,
   the said material or mixture of materials having been ground, if necessary, to obtain this particle size.

D90, D10, D50 means that 90%, 10%, 50% respectively of the particles by mass must have their smallest projected surface in each case of the size indicated.

For the aggregate to have the best properties, the mixture between the particulate starting material and the binder or binder-forming system must be optimal within the composite forming this aggregate, i.e. the material-binder/binder-forming system contact surface must be as large as possible. However, if this surface area is too large, the material absorbs too much water and/or binder and the composite is therefore weakened. The particular values of D90, D10 and D50 given above are advantageous for such optimisation.

The hardenable mineral binder(s) may be selected from:
(a) hydraulically setting cementitious binders, such as NF EN 206 standard cements like Portland CEM I and Portland CEM III;
(b) mixtures based on at least three components selected from clinkers, metakaolins, gypsum, slags, calcareous fillers, silica fume, ashes, pozzolans and pozzolanic materials; and
(c) mixtures of at least one binder defined in (a) and at least one component of a mixture as defined in (b)

The system or systems capable of forming a hardened mineral binder in an aqueous medium may consist of:
at least one precursor for forming a geopolymer or an activated alkali, chosen in particular from kaolins, metakaolins, shales, clays, slags, ashes and mixtures thereof, it being possible for the kaolins, shales and clays to have undergone a heat treatment such as calcination or flash treatment; and
at least one activator for forming an activated binder chosen from soda, potash and sodium and/or potassium silicates.

At least one shaping aid selected in particular from:
petroleum-based polymers, such as polyamides, as polyacrylamides, and concrete plasticizers and superplasticizers;
bio-based polymers, such as cornstarch or cellulose ether; and
mineral plasticisers, such as bentonite and non-reactive ash,
   may be incorporated into the mixture leading to the wet powder.

In a particularly preferred way, the mixture is obtained in the form of a wet powder from:
(A) 50 to 95 parts by weight, in particular 65 to 90 parts by weight, of said particulate starting material or materials; and
(B) 5 to 50 parts by weight, in particular 10 to 35 parts by weight, of said binder(s) and/or binder-forming system (s),
   the water is added in a proportion of 2 to 40 parts by weight and the shaping aid(s) may be added up to 5 parts by weight,
   all these parts by weight being given per 100 parts by weight of (A)+(B).

Water helps to harden the binder by participating in the hydraulic setting in the case of a hardenable mineral binder, or by constituting the medium in which the geopolymer or activated alkali is formed. Water can also assist the compression by liquefying the mass to be compressed.

It is advantageous to adjust the quantities of the mixture before compression to obtain a wet powder rheology corresponding to a class S1 to S3 concrete according to standard NF EN 12 350-2, in particular class S1 (slump between 10 and 40 mm at the Abrams cone).

Mixing can be carried out in a paddle, ploughshare, ribbon or planetary mixer for between 3 seconds and 3 minutes.

The wet powder is advantageously compressed by extrusion, in a single-screw extruder or in a twin-screw extruder or by pressing with the aid of a piston press or a vibro-compaction press in order to obtain the desired aggregate directly or in order to obtain a strand which is then cut into the desired aggregate or with the aid of a compression wheel which makes it possible to obtain the desired aggregate directly.

Compression allows several phenomena:
increase in the intrinsic density of the material;
intimate mixture of binder, material and water;
reduction in the intrinsic porosity of the material; and
creating a minimum cohesion before the end of the maturation phase.

This means that without compression, the composite cannot remain in aggregate form while the maturation process takes place and at best will be filled with pores with non-activated binder and at worst will disintegrate before it has fully set.

Either after compression, or after shaping, or after compression and after shaping, the hardened product or the aggregate can advantageously be matured as appropriate in a closed chamber for a period of 1 hour to 10 days at a temperature of 15 to 70° C.

The present invention also relates to an aggregate as obtained by the process as defined above, having at least one characteristic from among:
water absorption in accordance with standard NF EN 1097-6 of less than 37% by weight;
a density in accordance with standard NF EN 1097-6 of 1.4 to 3 g/cm³, preferably 1.6 to 2.5 g/cm³; and
a Los Angeles coefficient according to standard EN 1097-2 of less than 85, preferably 10 to 70.

The aggregate as defined above advantageously has a particle size of 4 to 70 mm, preferably 4 to 31.5 mm.

Another object of the present invention is the use of the aggregate produced by the process as defined above or of the aggregate as defined above, as aggregate for concrete (ready-mixed concrete, prefabricated concrete, etc.), as aggregate for asphalt mix, as backfill for geotechnical use, as road sub-base or as decorative aggregate, the said granular material being used alone or mixed with other aggregates, for example with conventional aggregates such as natural aggregates, artificial aggregates or even recycled aggregates based in particular on crushed concrete.

The following Examples illustrate the present invention without limiting its scope.

In these examples, percentages and parts are given by weight unless otherwise stated.

### EXAMPLE 1: MANUFACTURE OF AN AGGREGATE FROM CONSTRUCTION WASTE AND INERT MINERAL MATERIALS

A mixture of building and public works waste consisting of 30% organic materials based on wood, paper and cardboard and 70% a mixture of inert materials based on crushed concrete and gypsum was ground to a particle size defined by a D90 of 0.6 mm, a D10 of 0.04 mm and a D50 of 0.2 mm.

A mixture in the form of a wet powder was then prepared, with the following composition:

| | |
|---|---|
| Ground mixture obtained | 64.2 parts |
| CEM III cement (binder) | 35.8 parts |
| Water | 15 parts |
| Visco crete sika Dynamon NG (MBS ) | |
| superplasticizer (shaping aid) | 0.5 parts |

The mixture prepared in this way was then subjected to compression by passing it through a single-screw extruder, at the outlet of which the dehydrated bound mixture thus formed in the form of a strand was cut into an aggregate with a particle size of [10; 14] mm.

The aggregate was then matured in a closed chamber for 3 days at 20° C.

This aggregate presented:
a density of 1.8 g/cm³;
20% water absorption; and
a Los Angeles coefficient of 70.

### EXAMPLE 2: MANUFACTURE OF AN AGGREGATE FROM QUARRY FINES AND FLAX FIBERS

A mixture of 90% quarry fines and 10% flax fibers was ground to a particle size defined by a D90 of 1 mm, a D10 of 0.06 mm and a D50 of 0.2 mm.

A mixture in the form of a wet powder was then prepared, with the following composition:

| | |
|---|---|
| Ground mixture obtained | 75 parts |
| Mixture of 59.5% clinker, | 25 parts |
| 22.5% limestone and 1.5 of | |
| blast-furnace slag and 18% | |
| of limestone filler | |
| Water | 15 parts |
| Visco crete sika superplasticizer | 1 part |
| Dynamon NG (MBS) (shaping aid) | |

The mixture was then compressed in a piston extruder to obtain blocks of the dehydrated bonded mixture thus shaped, blocks which were then matured in a closed chamber for 3 days at 25° C.

At the end of the maturing process, the blocks obtained were crushed to obtain aggregates with a grain size of [4-30 mm].

This aggregate presented:
a density of 1.6 g/cm³;
20% water absorption; and
a Los Angeles coefficient of 50.

### EXAMPLE 3: MANUFACTURE OF AN AGGREGATE FROM COMMON INDUSTRIAL WASTE (CIW)

A mixture of construction and public works waste consisting of 30% organic materials based on wood, paper and cardboard and 70% a mixture of inert materials based on crushed concrete and gypsum was ground to a particle size defined by a D90 of 0.7 mm, a D10 of 0.1 mm and a D50 of 0.25 mm.

A mixture in the form of a wet powder was then prepared, with the following composition:

| | |
|---|---|
| Ground mixture | 54.2 parts |
| CEM I cement | 45.8 parts |
| Water | 25.4 parts |
| Bentonite (shaping aid) | 1.7 part |

The mixture prepared in this way was then compressed by a compaction wheel and matured at 45° C. for 5 days to obtain an aggregate with a particle size of 10-14 mm.

This aggregate presented:
a density of 1.6 g/cm³;
25% water absorption; and
a Los Angeles coefficient of 75

1-12. (canceled)

13. Process for manufacturing an aggregate, wherein at least one particulate organic or organic/mineral starting material for aggregate is mixed with water and at least one mineral binder which can be hardened in the presence of water and/or at least one system capable of forming a hardened mineral binder in an aqueous medium, in order to obtain a material in the form of a wet powder which is compressed by extrusion or pressing in order to intimately mix the binder and/or a system capable of forming the binder/the particulate starting material/water and to increase the intrinsic density and reduce the intrinsic porosity of the material, and to obtain, as a result of the hardening of the binder or binders, a hardened, solid mass which is in the form of the aggregate of the size and/or shape desired, or is transformed into the aggregate of the size and/or shape desired by cutting or crushing, immediately after compression or in a subsequent stage.

14. Process according to claim 13, wherein the particulate organic starting material is chosen from wood, paper, cardboard, plastics, plants, wood wool, household waste, biogenic waste, bituminous waste and mixtures thereof, and the starting particulate organic/mineral material is chosen from non-hazardous non-inert waste, and from the organic materials listed above in a mixture with at least one particulate mineral material chosen from sands; non-reactive clays; sediments; glass; gypsum; coal; crushed concrete; crushed aggregates; glass wool and rock wool; quarry fines; industrial process fines; and mixtures thereof.

15. Process according to claim 14, wherein the plants are chosen from flax fiber, hemp fiber, cellulose fiber, the non-hazardous non-inert waste is chosen from building waste and ordinary industrial waste, household waste and tertiary waste, the sands are chosen from silica sand and basalt sand, the sediments are chosen from dredging sediments.

16. Process according to claim 13, wherein the starting particulate organic or organic/mineral material or the mixture of starting particulate mineral materials have a particle size defined by:
a D90 value less than or equal to 2 mm;
a D10 value greater than or equal to 0.01 mm; and
a D50 value greater than or equal to 0.1 mm, and less than or equal to 1.1 mm,
the material or mixture of materials having been ground, if necessary, to obtain this particle size.

17. Process according to claim 16, wherein the D90 value is less than or equal to 1.1 mm; the D10 value is less than or equal 0.03 mm and the D50 value is greater than or equal to 0.35 mm and less than or equal to 0.8 mm.

18. Process according to claim 13, wherein the hardenable mineral binder or binders are chosen from:
(a) hydraulically setting cementitious binders;
(b) mixtures based on at least three components selected from clinkers, metakaolins, gypsum, slag, limestone fillers, silica fume, ash, pozzolans and pozzolanic materials;
(c) mixtures of at least one binder defined in (a) and at least one component of a mixture as defined in (b).

19. Process according to claim 18, wherein the hydraulically setting cementitious binders are chosen from Portland CEM I and Portland CEM III.

20. Process according to claim 13, wherein the system or systems capable of forming a hardened mineral binder in an aqueous medium consist of:
at least one precursor for forming a geopolymer or an activated alkali; and
at least one activator for forming an activated binder chosen from soda, potash and sodium and/or potassium silicates.

21. Process according to claim 20, wherein the at least one precursor for forming a geopolymer or an activated alkali is chosen from kaolins, metakaolins, shales, clays, slags, ashes and mixtures thereof, it being possible for the kaolins, shales and clays to have undergone a heat treatment.

22. Process according to claim 13, wherein at least one shaping aid chosen from:
petroleum-based polymers;
bio-based polymers; and
mineral plasticisers,
is incorporated into the mixture leading to the wet powder.

23. Process according to claim 22, wherein the petroleum-based polymers are chosen from polyamides, polyacrylamides, concrete plasticizers and superplasticizers, wherein the bio-based polymers are chosen from cornstarch and cellulose ether, and wherein the mineral plasticisers are chosen from bentonite and non-reactive ash.

24. Process according to claim 13, wherein the mixture is obtained in the form of a wet powder from:
(A) 50 to 95 parts by weight of particulate starting material or materials; and
(B) 5 to 50 parts by weight of binder(s) and/or binder-forming system(s),
the water is added in a proportion of 2 to 40 parts by weight and the shaping aid(s) may be added up to 5 parts by weight,
all these parts by weight being given per 100 parts by weight of (A)+(B).

25. Process according to claim 24, wherein the particulate starting material or materials are present at 65 to 90 parts by weight and the binder(s) and/or binder-forming system(s) are present at 10 to 35 parts by weight.

26. Process according to claim 13, wherein the wet powder is compressed by extrusion in a single-screw extruder or in a twin-screw extruder or by pressing with the aid of a piston press or a vibro-compaction press in order to obtain the desired aggregate directly or in order to obtain a strand which is then cut into the desired aggregate or with the aid of a compression wheel which makes it possible to obtain the desired aggregate directly.

27. Process according to claim 13, wherein, either after compression, or after shaping, or after compression and after shaping, the hardened product or the aggregate is matured, as appropriate, in a closed chamber for a period of 1 hour to 10 days at a temperature of 15 to 70° C.

28. Aggregate obtained by the process as defined in claim 13, having at least one of:
water absorption in accordance with standard NF EN 1097-6 of less than 37% by weight;
a density according to standard NF EN 1097-6 of 1.4 to 3 g/cm³; and
a Los Angeles coefficient according to standard EN 1097-2 of less than 85.

29. Aggregate according to claim 28, wherein the density is 1.6 to 2.5 g/cm³ and wherein the Los Angeles coefficient is between 10 and 70.

30. Aggregate according to claim 28, wherein the aggregate has a particle size of 4 to 70 mm.

31. Aggregate according to claim 30, wherein the aggregate has a particle size of 4 to 31.5 mm.

32. Aggregate manufactured by the process according to claim 13, for use as aggregate for concrete, as aggregate for asphalt, as backfill for geotechnical use, as road sub-base or as decorative aggregate, said aggregate material being used alone or mixed with other aggregates.
